(19) United States
(12) Patent Application Publication
(10) Pub. No.: US 2004/0030835 A1
(43) Pub. Date: Feb. 12, 2004

(54) Efficient cache organization for way-associativity and high refill and copy-back bandwidth

(76) Inventor: Jan-Willem van de Waerdt, Sunnyvale, CA (US)

Correspondence Address: Corporate Patent Counsel, Philips North America Corporation, 580 White Plains Road, Tarrytown, NY, 10591, US

(21) Appl. No.: 10/218,080

(22) Filed: Aug. 12, 2002

(51) Int. Cl. G06F 12/00

(52) U.S. Cl. 711/128; 711/131; 711/167

(57) ABSTRACT

In a cache memory access operation data words are retrieved from the cache memory in dependence upon whether the data word reside in the cache memory. If the words reside in cache memory they are provided from the cache memory to a processor, if not then they are brought into cache memory from a main memory. Unfortunately, the data words are stored in cache memory in such a manner that accessing of the cache memory multiple times is required in order to retrieve a single cache line. During the retrieval of the single cache line, the cache memory cannot be accessed for other operations such as cache line refill and copy-back. This results in the processor to incur stall cycles while waiting for these operations to complete. By storing the cache line in such a manner that it spans multiple memory circuits, the processing stall cycles are decreased since fewer clock cycles are required to retrieve the entire cache line from the cache memory. Therefore, more clock cycles are available to facilitate cache line refill and copy-back operations.

### FIELD OF THE INVENTION

The invention relates to cache memories and more specifically to cache memory architectures that facilitate high bandwidth cache refill and copy back operations while at the same time providing high way-associativity.

### BACKGROUND OF THE INVENTION

As integrated circuit technology progresses to smaller feature sizes, faster central processing units (CPU)s are being developed as a result. Unfortunately access times of main memory, in the form of random access memory (RAM), where instruction data is typically stored, have not yet matched those of the CPU. In use, the CPU accesses these slower devices in order to retrieve instructions therefrom for processing thereof. In retrieving these instructions a bottleneck is realized between the CPU and the slower RAM. Typically, in order to reduce the effect of this bottleneck a cache memory is implemented between the main memory and the CPU to provide most recently used (MRU) instructions and data to the processor with lower latency.

It is known to those of skill in the art that cache memory is typically smaller in size and provides faster access times than main memory. These faster access times are facilitated by the cache memory typically residing within the processor, or very close by. Cache memory is typically of a different physical type than main memory. Main memory utilizes capacitors for storing data, where refresh cycles are necessary in order to maintain charge on the capacitors. Cache memory on the other hand does not require refreshing like main memory. Cache memory is typically in the form of static random access memory (SRAM), where each bit is stored without refreshing using approximately six transistors. Because more transistors are utilized to represent the bits within SRAM, the size per bit of this type of memory is much larger than dynamic RAM and as a result is also considerably more expensive than dynamic RAM. Therefore cache memory is used sparingly within computer systems, where this relatively smaller high-speed memory is typically used to hold the contents of the most recently processor utilized blocks of main memory.

The purpose of the cache memory is to increase instruction and data bandwidth of information flowing from the main memory to the CPU. The bandwidth is measured by an amount of clock cycles required in order to transfer a predetermined amount of information from main memory to the CPU. The fewer the number of clock cycles required the higher the bandwidth. There are different configurations of cache memory that provide for this increased bandwidth such as direct mapped and cache way set-associative. To many of skill in the art it is a fact that the cache way set-associative cache structure is preferable.

Cache memory is typically configured into two parts, a data array and a tag array. The tag array is for storing a tag address for corresponding data bytes stored in the data array. Typically, each tag array entry is associated with a data array entry, where each tag array entry stores index information relating to each data array entry. Both arrays are two-dimensional and are organized into rows and columns. A column within either the data array or the tag array is typically referred to as a cache way, where there can be more than one cache way in a same cache memory. Thus a four-cache way set-associative cache memory would be configured with four columns, or cache ways, where both the data and tag arrays also have four columns each. Additionally, cache memory is broken up into a number of cache lines, where each line provides storage for a number of addressable locations, each location being several bytes in width.

During CPU execution both main memory and cache memory are accessed. In a data cache memory access operation the set-associative cache is accessed by a load/store unit, which searches the tag array of the cache for a match between the stored tag addresses and the memory access address. The tag addresses within the tag array are examined to determine if any match the memory access address. If a match is found, the access is said to be a data cache “hit” and the cache memory provides the associated data bytes to the CPU from the data array. The data bytes, stored within a cache line within the data array, are indexed by the tag address where each cache line has an associated tag address in the tag array. Of course, to those of skill in the art it is known that the load/store unit access the data cache and an instruction fetch unit is used to accesses the instruction cache.

If a match is not found, the access is said to be a data cache “miss.” When a data cache miss occurs, the processor experiences stall cycles. During the stall cycles the load/store unit retrieves required data from the main memory in a cache refill operation. Typically in the refill operation the load/store unit performs a burst operation that fills the cache with the requested data from main memory, and with data surrounding the requested data in an amount to completely fill a cache line. For example, if a cache line included four addressable locations, and each location is eight bytes in width, a burst performs a transfer of four 8-byte wide elements to fill the entire cache line. Once the cache line is filled, the requested data is provided to the processing system. By bursting data into a cache to fill an entire cache line, the cache exploits expected spatial locality in cache accesses, thus reducing time spent retrieving future cache data words. Unfortunately, copying multiple data elements of a cache line into the data cache may interfere with normal cache access operations. Typically, the CPU has to wait until the cache line is full before it can access the requested data, which creates added delay for the CPU.

In some cases the delay created by the cache line refill operation is remedied by simultaneously providing the data bytes to the CPU in parallel with providing the data to the cache. Thus, as soon as the requested data is available to the cache, it is forwarded to the processing system. However, subsequent requests to access data in other locations within the cache line require the processing system to wait until the entire cache line is filled. This is true even if the particular location of interest has been stored within the cache system. Thus, requiring the CPU to wait until an entire cache line is filled before allowing access to data within a cache line creates delays. What is needed is a method and apparatus which fills a cache line, but which also provides immediate access to locations within a cache line, even before the entire cache line is filled. For instance, U.S. Pat. No. 5,835,929, entitled, “Method and apparatus for sub cache line access and storage allowing access to sub cache lines before completion of a line fill,” discloses a method of making sub cache lines available to the CPU as they are filled, rather than waiting for the entire cache line to be filled. Thereby, reducing the delays incurred by the CPU during a cache line refill operation.

In a write back operation, or copy-back operation, the load/store unit updates main memory with a changed cache line for a data cache. For an instruction cache, the instruction fetch unit updates the main memory with the changed cache line. Typically, in the prior art, write backs have been implemented by either performing the write back operation prior to the replacement of the cache line with the new data or alternatively, by using a write back buffer. The write back buffer is a special buffer that holds the updated data from the cache line being replaced, so that the cache line is free to accept the new data when it arrives and takes its place in the cache.

Unfortunately, using traditional data organization way-associative caches provides a difficulty in delivering high bandwidth for cache line refill and copy-back operations. This is because the data is organized in cache memories in such a manner so as to provide a required way-associativity for efficient operation. Where, for way-associativity, data is organized to be able to provide simultaneous access to words from corresponding cache line locations for multiple lines residing in the same set. In an N-way set associative cache configuration, N words typically need to be accessed simultaneously in order to make up the require data by the CPU.

For line refill and line copy-back it is desirable to have as high a bandwidth cache configuration as possible, since high bandwidth increases processor performance. To those of skill in the art it is known that refill and copy-back operations produce interference cycles with respect to normal cache operations. When a refill or copy-back operation is being performed, the cache cannot be simultaneously used for performing word retrievals for load instructions or word updates for store instructions, thereby reducing processing potential of the processor. Unless of course the cache memory is multi-ported, however this is costly to implement in terms of die area since additional circuitry is used for the implementation thereof.

A need therefore exists to provide a cache memory architecture that allows for cache access while simultaneously supporting cache line refill and copy-back operations. It is therefore an object of this invention to provide an improved cache organization that facilitates an increased cache bandwidth by permitting cache line refill and copy-back operations.

### SUMMARY OF THE INVENTION

In accordance with the invention there is provided a method of storing a plurality of sequential data words in a cache memory comprising the steps of: providing a cache line comprising a plurality of sequential data words; and, storing the plurality of sequential data words located within the cache line spanning a first memory circuit and a second memory circuit in such a manner that adjacent data words within the cache line are stored in other than a same memory circuit at other than a same address within each of the first and the second memory circuits.

In accordance with the invention there is also provided a cache data array, disposed within a cache memory, for storing a plurality of sequential data words, the data array comprising: a first memory circuit having a first cache way therein for storing a first data word from the plurality of data words in a first memory location; a second memory circuit having a second cache way therein for storing a second data word from the plurality of data words in a second memory location; said first and second memory words stored in a same cache line and spanning said first and second cache ways, where adjacent data words are other than stored in a same memory circuit, with said first and second memory locations having an address within the cache way that is other than the same address.

### BRIEF DESCRIPTION OF THE DRAWINGS

Exemplary embodiments of the invention will now be described in conjunction with the following drawings, in which:

FIG. 1 illustrates a prior art cache memory organization;

FIG. 2 illustrates another prior art cache memory having partial write enable functionality;

FIG. 3a illustrates an embodiment of the invention, a diagonal organization of data words from a same cache line over multiple cache memories;

FIG. 3b illustrates a cache memory architecture having diagonally organized data words within the data array;

FIG. 4 illustrates another embodiment of the invention, a separate memory circuit provide for each cache way;

FIG. 5 illustrates where data words are arranged in a predetermined pattern other than diagonally; and,

FIG. 6 illustrates a horizontal organization of cache line words over multiple memory circuits.

### DETAILED DESCRIPTION OF THE INVENTION

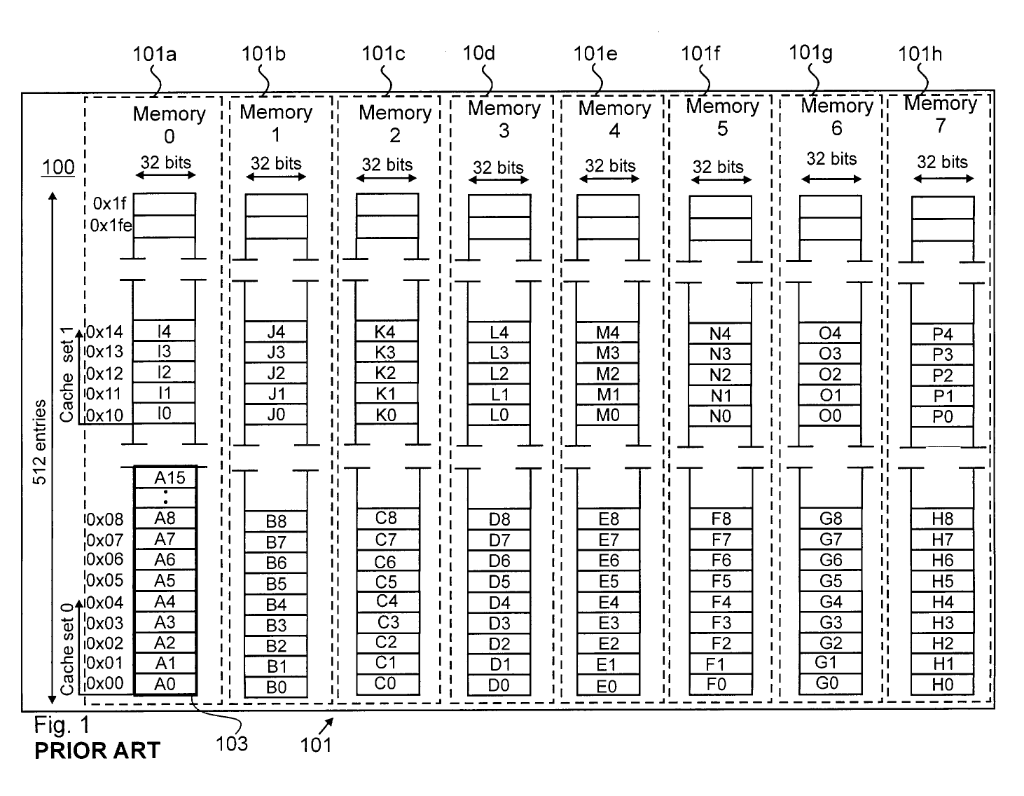

Prior Art FIG. 1 illustrates a prior art data array architecture 100 for use in a cache memory system (not shown). This data array architecture 100 is comprised of eight memory circuits 101a to 101h. Each of the memory circuits 101 is 512*32 bits in size and each of the memory circuits 101 provides a cache way within the cache memory system. Therefore, each memory circuits provides a storage array for storing 512*32-bit data words, or 0x200*32-bit data words. The resulting cache memory is defined as being 8 way set associative because of the eight memory circuits 101a to 101h, with each memory circuit contributing to a cache way. The total size of the data array architecture 100 in this cache memory is 16 Kbytes. A size of the cache line 103 in this case is 64 bytes, with a cache line count of 256, and a cache set count of 32. The 4-byte data words stored within a cache line X are named X0, X1, X2, . . . , X15, in ascending sequential word addresses, where 4 bytes per data word times 16 data words equals the size of the cache line 103 of 64 bytes.

In this example, cache way 0 101a is for storing data words contained in cache lines A and I, cache way 1 101b is for storing data words contained in cache lines B and J, cache way 2 101c is for storing data words contained in cache lines C and K, cache way 3 101d is for storing data words contained in cache lines D and L, cache way 4 101e is for storing data words contained in cache lines E and M, cache way 5 101f is for storing data words contained in cache lines F and N, cache way 6 101g is for storing data words contained in cache lines G and O, and cache way 7 101h is for storing data words contained in cache lines H and P. A first cache set contains data words: A, B, C, D, E, F, G, and H, and a second cache set contains data words: I, J, K, L, M, N, O, and P. A data word is the element that is transferred to and from the cache memory by a load/store unit (not shown) as a consequence of processor store and load operations. In this case a word size of 32-bits/4-bytes is assumed, where the width of each of the memory circuits within the data array is 32 bits wide.

Each of the memory circuits 101 is provided with an address port, a write enable port, a read enable port and a data port. When an address is provided to the memory circuit 101 at the address port and a read signal is asserted at the read enable port, the memory circuit is configured to provide data residing within the address to the data port. Similarly, when the address is provided to the memory circuit 101 and the memory circuit is write enabled, data residing at the data port is stored within the memory circuit at the provided address. As is seen from the example in FIG. 1, the entire contents of a single cache line are stored within a same memory circuit 101. Of course, though data is referred to as being stored to or retrieved from an address, it is actually stored and/or retrieved from a memory location indexed by the address. Of course, the terms storing to and retrieving from an address are well understood by those of skill in the art.

Unfortunately, simultaneous access to multiple cache words within the same cache line is prevented because each cache line is located in one single-ported cache memory circuit. In order to extract data words A0 through A15 from cache way 0 101a, at least sixteen clock cycles are required to set the address for each of the data words on the address port and to assert sixteen reads in order to provide the desired cache line to the processor. Having to sequentially access the cache memory a plurality of times to retrieve a single cache line is not advantageous because valuable processing time may be wasted.

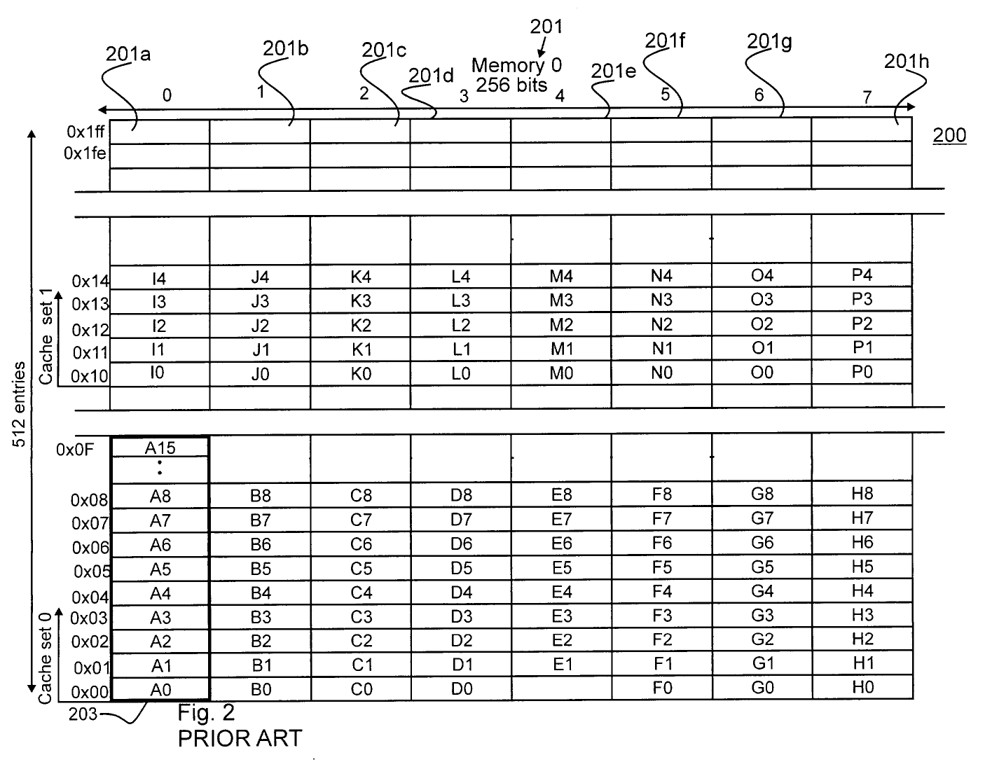

Prior Art FIG. 2 illustrates another data array architecture 200, within the cache memory. More specifically the memory circuit shown for implementation of the data array, has a partial write enable functionality, thus providing a different data organization than the data array architecture 100. This possible organization uses a single memory circuit of 512*256 bits, 128 Kbits or 16Kbytes in size, with partial write enable at 32-bit word resolution. Each cache line 203 is 64 bytes long. The data words stored within a cache line X are named X0, X1, X2, . . . , X15, in ascending sequential word addresses, where 4 bytes per data word times 16 data words equals the cache line 203 size of 64 bytes.

In the example shown in FIG. 2, the cache ways 201a to 201h are the columns of this data array and not individual memory circuits 101 as shown in FIG. 1. The single memory circuit 201 is provided with an address port, a write enable port, a read enable port and a data port. When an address is provided to the memory circuit 201 at the address port and a read signal is asserted at the read enable port, the memory circuit is configured to provide data residing at the address to the data port. Similarly, when the address is provided to the memory circuit 201 and the memory circuit is write enabled, data residing on the data port is stored within the memory circuit. Using partial write enable within the memory circuit to either write upper or lower 32-bit data elements at a specific address location within the memory circuit. As is seen from the example in FIG. 2, the entire contents of a single cache line are stored within a same memory circuit 201. Therefore, as was the case in the example of FIG. 1, at least sixteen clock cycles are utilized in order to retrieve a single cache line from the cache memory since the memory does not facilitate parallel reading of data words contained at different addresses therein. A separate address and a separate read signal are asserted on the address and read ports, respectively, in order to facilitate extraction of the entire cache line from the single memory circuit 201.

Therefore, both of these prior art data array architectures are plagued with limited bandwidth for cache line refill and copy back operations. Cache line refill operations require writing to the data array and copy-back operations require reading from the data array. When the data array is being accessed by the load/store unit to provide data to the processor, the copy-back and refill operations interfere with the cache memory access and thereby cause processor stall cycles thus increase processing time. Simultaneous access to multiple data words within the same cache line is excluded because each cache line is located in one single-ported memory circuit. Of course to those of skill in the art it may be obvious to duplicate the amount of memory ports within the cache memory by either having two copies of the cache memory stored within two different memory circuits, or by multi-porting each memory circuit itself, however it is also known that this results in a substantial increase in required chip area, thereby increasing manufacturing costs. It would be advantageous to provide a cache memory architecture that facilitates decreased processor stall cycles by providing data words to the processor while allowing for simultaneous cache line refill and copy-back operations.

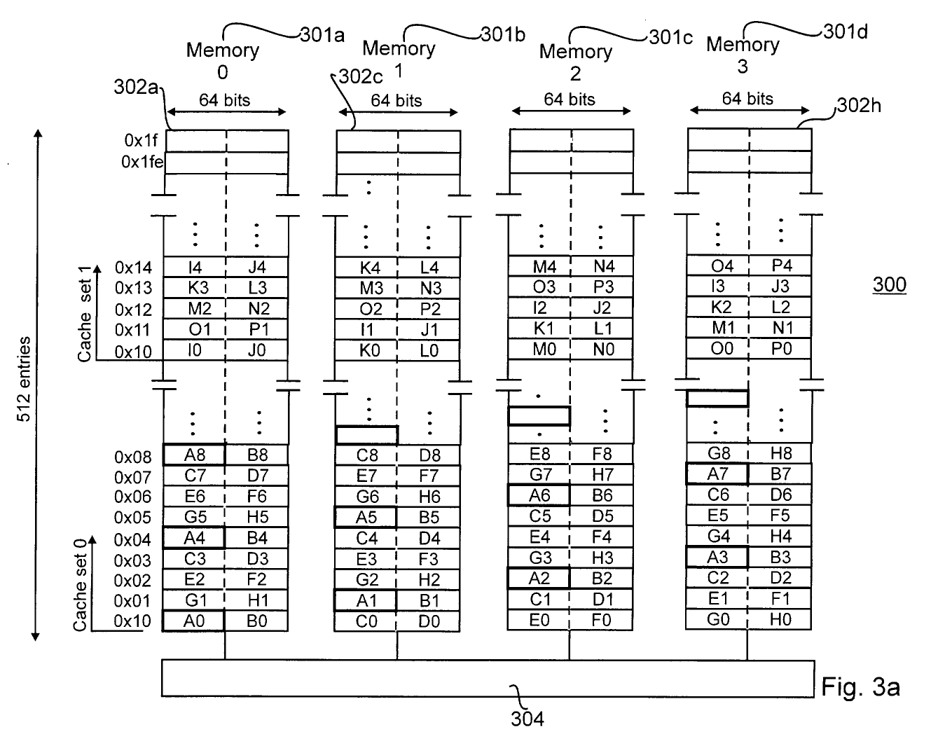

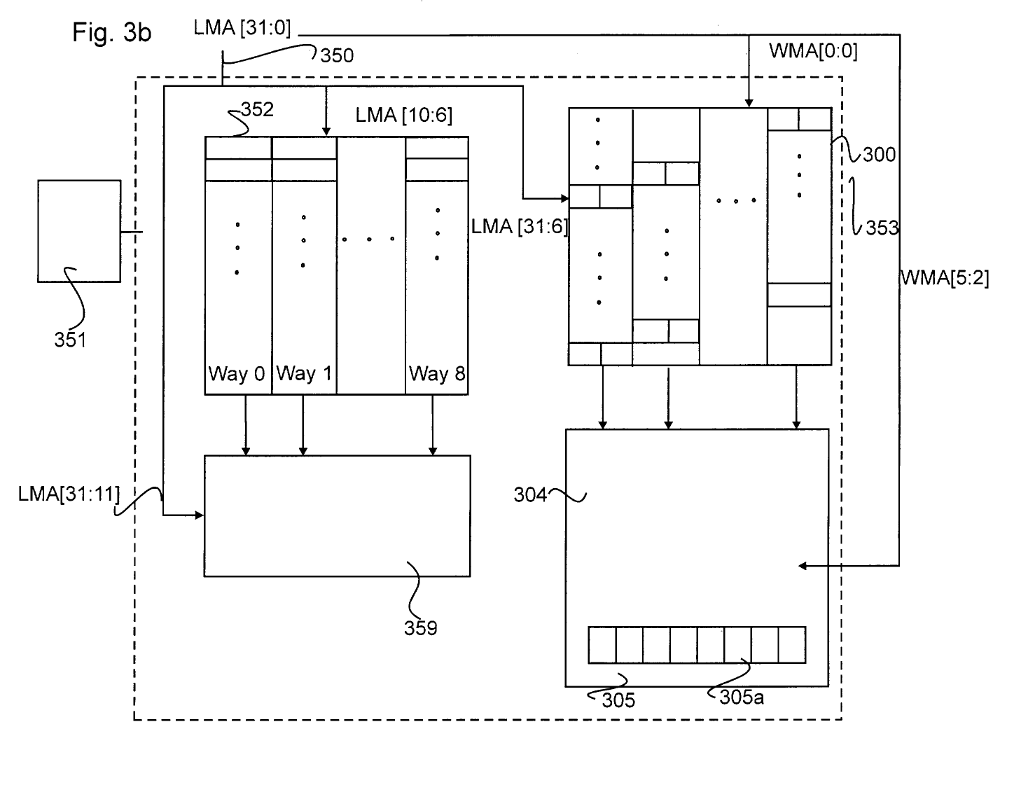

FIG. 3a illustrates an example embodiment of the invention. This embodiment provides a diagonal organization of cache line data words within a same cache line relative to cache ways 302a to 302h over multiple memory circuits 301a-301d, making up the data array architecture 300. In this embodiment, the data array architecture has a size of 16 Kbytes, being 8 way set associative and having a 64-byte line size. This results in a cache way size of 2 Kbytes, a cache line count of 256, and a cache set count of 32. The data array architecture in this case uses four memory circuits 301a-301d, with each memory circuit 301 being an array of 512 rows, with each row for storing 64 bits. Each of the memory circuits 301 has a capability to modify either the higher or lower 32-bits of each 64-bit memory double word 310. Being able to modify either the higher or lower bytes of each memory double word thus provides a write enable at 32-bit resolution. For a cache line X, the data words are named X0, X1, X2, . . . , X15, in ascending sequential word addresses order, with each data word stored in either the higher or lower 32 bits of each memory double word.

Each of these memory circuits 301 is provided with an address port, a write enable port, a read enable port and a data port. When an address is provided to the memory circuit 301 at the address port and a read signal is asserted at the read enable port, the memory circuit is configured to provide data residing at the provided address to the data port. Similarly, when the address is provided to the memory circuit 301 and the memory circuit is write enabled, data provided at the data port is stored within the memory circuit.

In this data array architecture 300, the cache lines and cache ways are not contained within a single memory, but instead each cache line is stored across the four memory circuits 301a to 301d. Using cache line A0 . . . A15 for example, it can be seen in FIG. 3a that cache line A0 . . . A15 traverses the four cache memory circuits four times. The first data word A0 is located in the higher 32 bits of first memory circuit 301a at address 0x00, the second data word A1 is located in the higher 32 bits of second memory circuit 301b at address 0x01, the third data word A2 is located in the higher 32 bits of second memory circuit 301c at address 0x02, and the fourth data word A3 is located in the higher 32 bits of fourth memory circuit 301d at address 0x03. The fifth data word A4 is again located in the first memory circuit 301a at address 0x04 and so on, up to the sixteenth data word A15 located at address 0x0F. The lower 32 bits of the first memory circuit 301a, also located at address 0x00 contain the first data word B0 of cache line B0 . . . B15. The cache line is diagonally oriented across the memory circuits instead of having all of its contents being located in a single memory circuit.

Cache way 0 is for storing data words contained in cache lines A and I, cache way 1 is for storing data words contained in cache lines B and J, cache way 2 is for storing data words contained in cache lines C and K, cache way 3 is for storing data words contained in cache lines D and L, cache way 4 is for storing data words contained in cache lines E and M, cache way 5 is for storing data words contained in cache lines F and N, cache way 6 is for storing data words contained in cache lines G and O, and cache way 7 is for storing data words contained in cache lines H and P. In this case, each of the cache ways is not contained in a single memory circuit, instead each cache way is spread over the four memory circuits. Where for example cache lines A and I are contained in a same cache way, but the cache way spans across the four memory circuits.

Each of these memory circuits 301, only facilitates a read operation, or a write operation. Advantageously though, the reading of a cache line from this architecture 300 is fast because less clock cycles are required in order to extract a single cache line from this data array architecture 300. In one clock cycle data words A0 . . . A3 are transferable into a data buffer 304. Therefore, in four clock cycles an entire cache line is extracted from the memories 301a-301d instead of requiring at least fifteen clock cycles. This is facilitated by providing the diagonally orientation of the cache lines and cache ways. For extracting words A0 . . . A3, addresses 0x00, 0x01, 0x02, 0x03 are latched on to the address port of the four memory circuits 301a to 301d, respectively, and when a read signal is asserted, in parallel, on each of the read ports on each of the memory circuits, four data words are extracted from the data array into the data buffer 304. For extracting data word I0 for instance, address 0x10 is latched onto the address ports of the first memory circuit and data word I0 is provided to the data buffer 304. Advantageously, because the data words are stored using different addresses within the data array architecture 300, shifting of the retrieved data words within the data buffer 304 is not necessary.

Of course, though the term diagonal is used to describe the arrangement of the data words (as shown in FIG. 3a), it is also possible to arrange the data words in a known pattern so as to provide the advantages of the present invention.

FIG. 3b illustrates a cache memory architecture with a cache memory 353 having a size of 16 Kbyte and being 8 way set associative. The cache memory 353 has 256 lines, resulting from the 16 Kbyte cache memory size divided by the 64 byte line size. With the provided 8 cache way set associativity, there are 256 lines/8=32 sets in the cache memory. Within the cache memory 353 there is a tag array 352 and a data array 300 in accordance with an embodiment of the invention. The organization of tags in the tag array is performed in accordance with prior art cache memory design techniques. In accordance with the architecture shown in FIG. 3b, to identify a byte in the main memory 351a byte address BA[31:0] is used with a cache line size of 64 bytes or 16 words, a word being 4 bytes in this case. All bits within the BA[31:0] are necessary to identify the byte within the main memory 351.

To identify a cache line in the main memory 351a line address LMA[31:0] is used, where only address bits 31 down to bit 6 are necessary to identify a line in the case where the cache line is 64-byte aligned. LMA[31:0] is provided on a request address bus 350 to the cache memory architecture of FIG. 3b. LMA[31:6] is used to address a cache line. A word memory address WMA[31:0] is used to identify a data word in the main memory. However, within the WMA, only address bits 31 down to bit 2 are necessary to identify each data word, where the data words are 4-byte aligned within the main memory 351. WMA[5:2] is provided to the data buffer 304 to index a specific data word 305a from within a retrieved cache line 305.

The tag array 352 provides the tag addresses of the eight lines residing in the cache set at set address LMA[10:6]. These tags present address bits 31 down to 11 of the cache lines present in the indexed set. Address bits 10 down to 6 are not required because these are the same as the set address used to index the cache memory since all cache lines in same cache set have address bits 10 down to bit 6 that are equal.

In order to determined whether a cache hit has resulted, 8 retrieved tags from the tag array 352 are compared to the line address bits LMA[31:11] to see if the requested line is in the cache memory 353 in order to obtain a cache hit and information relating to a cache way in which the requested cache line resides. Within the cache tag array is stored a tag array entry tag address A[31:11] that indexes a set address A[10:6] within the data array 300, reflecting one of the 8 cache ways when the requested data word results in a cache hit. Using the result of the tag comparison, the data word 305a from the retrieved cache line that resided in the cache way that provided the cache hit is selected.

Since there is no one-to-one relationship between a cache way, and a cache memory 301 in which the data for a cache line is located, the 8 data words retrieved from the cache memories are preferably organized within the retrieved cache line 305 within the data buffer 304 before a cache way selection is performed.

In the data array architecture 300, the memory circuits facilitate storing of 64 bit words—double words. These double words are twice as long as 32-bit data word. Therefore, for the data array architecture shown in FIG. 3a, for each data word retrieved from the data array, a way identifier is used to determine whether to select the higher or lower 32 bits of the retrieved double word from each memory circuit. The lowest bit of the WMA serves as of a cache way identifier, where an odd value of for instance 1,3,5,7, or even value of for instance 0,2,4,6 determines whether to choose the lower 32 bits or higher 32 bits, respectively, of the stored double word in the cache memory. To determine which memory circuit is providing which of the four words, upper two bits of the cache way identifier are utilized.

For example, four sequential data words with WMAs 0x100, 0x104, 0x108, and 0x10C are situated in same cache line spanning across the cache ways. The data words are found in memory circuits (0+1) mod 4, (1+1) mod 4, (2+1) mod 4, and (3+1) mod 4, at the respective WMAs. In this the way identifier is odd and therefore the lower 32-bits of the retrieved double words are selected and stored within the data buffer 304. Using the same example, for WMA 0x00, data words A0 and B0 are retrieved from the first memory circuit 301a, however since the way identifier is odd, the lower 32 bits, or B0, is stored within the data buffer 304. This exemplifies how the first four data words of the cache line are retrieved from the cache memory 300.

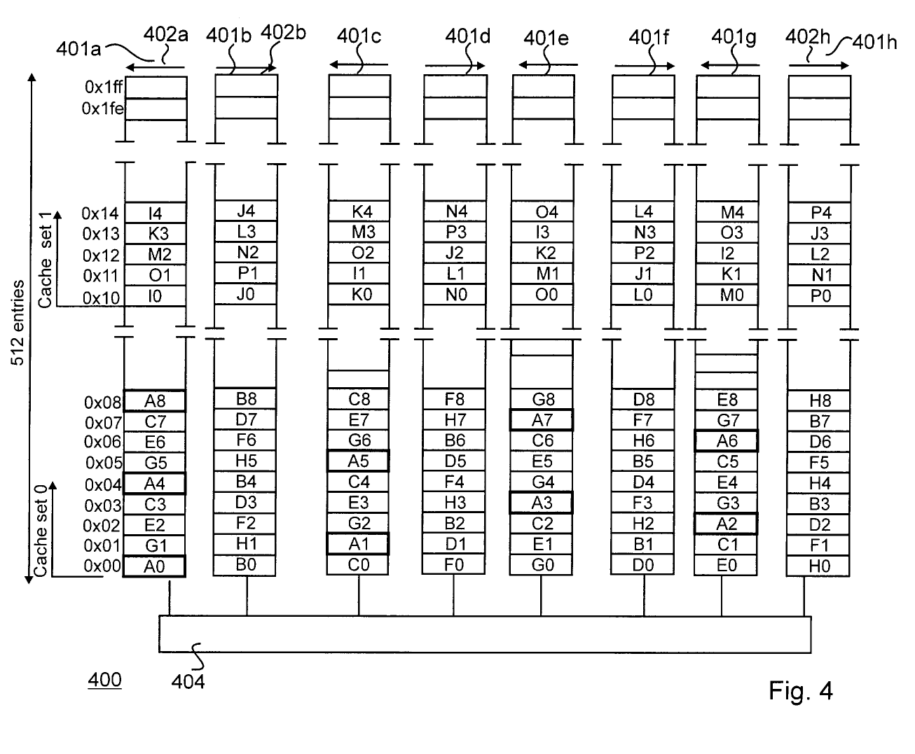

FIG. 4 illustrates a variation of an embodiment of the invention, a diagonal organization of cache line words over multiple memory circuits 401a through 401h supporting multiple cache ways 402a through 402h making up the data array 400. The cache memory has a size of 16 Kbytes, being 8 way set associative and having a 64 byte line size. This results in a cache way size of 2 Kbytes, a cache line count of 256, and a cache set count of 32. The memory organization in this embodiment uses eight memory circuits 401a through 401h of 512*32 bits each, or 16 Kbits, 2 Kbytes. A write enable at 32-bit resolution is utilized. The data words within a cache line X 503 are named X0, X1, X2, . . . , X15, in ascending sequential word addresses order. Of course a same number of memory circuits is optionally provided as a same number of data words within the cache line. In this manner, all of the data words are retrievable from the cache memory in a single memory access cycle. Upon completion of the single memory access cycle, the retrieved data words are provided within a data buffer 404.

Advantageously, this diagonal word organization allows for high associativity by providing simultaneous access to data words from corresponding cache line locations for multiple lines residing in the same set. It also advantageously provides a high bandwidth for cache line refill and copy-back by allowing for simultaneous access to multiple cache data words in the same cache line. Preferably, in order to increase the bandwidth further, the cache memory is dual ported by duplicating the configuration illustrated in FIG. 3a. In this case both copies of the configuration contain same information and hence double the copy-back bandwidth is supported. The cache refill bandwidth remains unchanged since both copies are updated with same information during a refill operation.

Of course, the examples shown in FIGS. 3a and 4 illustrate possible organizations for a data array architecture within a specific cache memory configuration. It will however be evident to those of skill in the art that other cache memory organizations are possible making different design trade-offs between memory size and memory access characteristics, such as partial write enable refill/copy-back bandwidth.

For the data array architecture disclosed in FIG. 3a, four clock cycles are used to retrieve a complete cache line, 16 words, from the data array. The cache cannot retrieve and provide the cache line at once because four data words from the same cache line reside in the same single ported data memory structure. Of course, providing 8 data memory circuits, as shown in FIG. 4, thus allows for retrieve of 8 data words from a same cache line in a single cycle. Thus enabling retrieval of a single cache line from the data array in as little as two cycles. Unfortunately, 8 half sized memory circuits occupy a larger chip area than 4 full sized memory circuits and therefore this is often a less advantageous implementation.

Additionally, when a cache line is retrieved from cache memory, it is provided from the cache memory into a cache buffer. If this cache buffer, or other cache line requesting elements cannot support the higher bandwidth provided by the faster cache access, a performance bottleneck results somewhere in the system. Typically cache lines are transmitted/received to/from the data array using a bus interface with limited data bandwidth. Thus, the positive effect of retrieving 8 data elements at once from the data array, typically require a data bus capable of handling the increased bandwidth. Alternatively, a buffering system is used to provide the data to the bus in portions suited to the bus. Of course, if the rest of the system is configured to allow for efficient processing of the retrieved cache lines then it is advantageous to provide a data array that facilitates retrieval of more data words in less clock cycles.

Advantageously, cache line refill and cache line copy-back operations are facilitated by the diagonal organization of the cache memory. Since four data words are retrievable from the cache memory architecture in a single clock cycle, there is plenty of time remaining for the additional operations of cache line refill and copy back to complete. In fact, there are three additional clock cycles unaccounted for that previously had been used for retrieving of the three data words making up the same cache line. But since the data words are retrieved in a single clock cycle, the additional three clock cycles facilitate copy back and cache refill operations, thus advantageously reducing processor stall cycles.

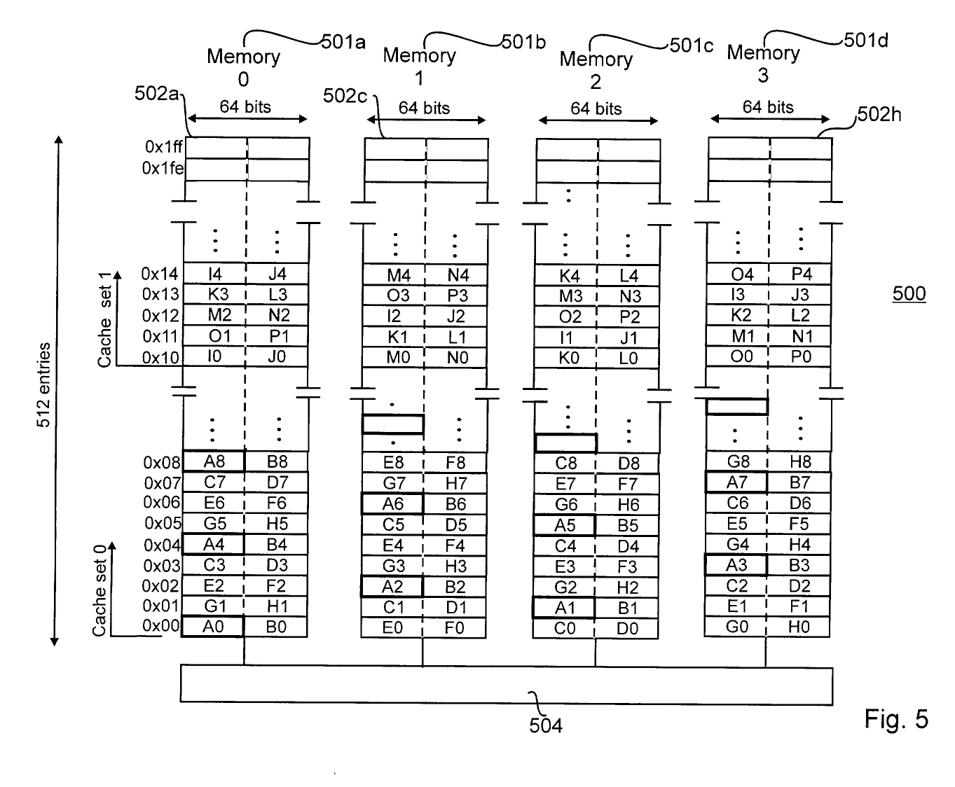

Referring to FIG. 5, an embodiment is shown wherein the data words are arranged in a predetermined pattern other than diagonally. This embodiment provides an other than diagonal organization of cache line data words within a same cache line relative to cache ways 502a to 502h over multiple memory circuits 501a-501d, making up the data array architecture 500. In this embodiment, the data array architecture has a size of 16 Kbytes, being 8 way set associative and having a 64-byte line size. This results in a cache way size of 2 Kbytes, a cache line count of 256, and a cache set count of 32. The data array architecture in this case uses four memory circuits 501a-501d, with each memory circuit 501 being an array of 512 rows, with each row for storing 64 bits. Each of the memory circuits 501 has a capability to modify either the higher or lower 32-bits of each 64-bit memory double word 510. Being able to modify either the higher or lower bytes of each memory double word thus provides a write enable at 32-bit resolution. For a cache line X, the data words are named X0, X1, X2, . . . , X15, in ascending sequential word addresses order, with each data word stored in either the higher or lower 32 bits of each memory double word. Of course, as is evident to those of skill in the art, such a pattern is an equivalent to the diagonal implementation with the numbering of the cache ways modified.

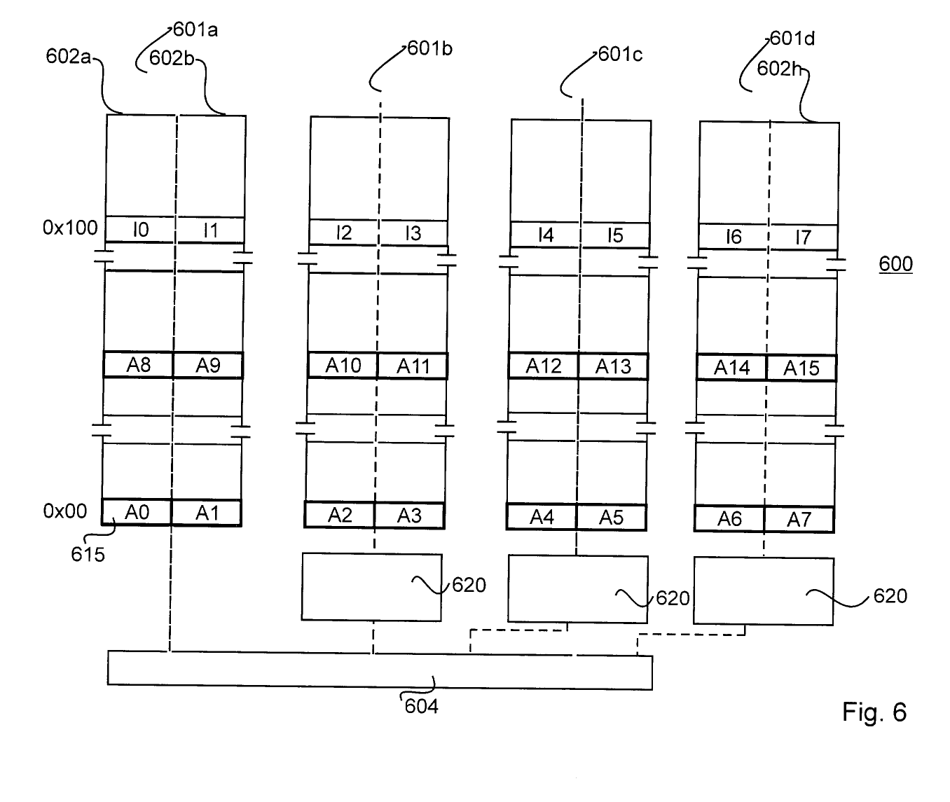

FIG. 6 illustrates another embodiment, a horizontal organization of cache line words over multiple memory circuits 601 making up the cache memory 600. In this embodiment, the cache configuration has a size of 16 Kbytes, being 8 way set, 602a through 602h, associative and having a 64 byte line size. This results in a cache way size of 2 Kbytes, a cache line count of 256, and a cache set count of 32. The memory organization in this embodiment uses four memories 601a through 601d of 512*64 bits each, or 32 Kbits, 4 Kbytes. A write enable at 32-bit resolution is utilized. The data words contributing to a same cache line X are named X0, X1, X2, . . . , X15, in ascending sequential data word addresses order. Each data word 615 is stored at a same address within each cache way. Therefore, a shift circuit 620 is provided for three of the four memories 601 in order to change a bit position of a retrieved data word from each of the cache ways 602 prior to storing these data words within the data buffer 604.

Numerous other embodiments may be envisaged without departing from the spirit or scope of the invention.

What is claimed is:

1. A method of storing a plurality of sequential data words in a cache memory comprising the steps of:
providing a cache line comprising a plurality of sequential data words; and,
storing the plurality of sequential data words located within the cache line spanning a first memory circuit and a second memory circuit in such a manner that adjacent data words within the cache line are stored in other than a same memory circuit at other than a same address within each of the first and the second memory circuits.

2. A method according to claim 1, comprising the steps of:
providing the first memory circuit having a first cache way therein for storing a first data word from the plurality of sequential data words in a first memory location; and,
providing the second memory circuit having a second cache way therein for having stored therein a second data word from the plurality of sequential data words and adjacent the first data word within the cache line.

3. A method according to claim 2, wherein the step of storing of at least two sequential data words located within the same cache line is performed during a single cache memory access cycle.

4. A method according to claim 3, wherein the step of storing four sequential data words located within the same cache line is performed during a single cache memory access cycle.

5. A method according to claim 2, comprising the step of retrieving said first and second data words in a single cache memory access cycle after the step of storing.

6. A method according to claim 5, wherein the data words retrieved from the cache are stored in a data buffer at a byte location within the data buffer, the byte location being dependent upon an address of each data word stored within each memory circuit.

7. A method according to claim 5, wherein the step of retrieving the data words is absent a step of shifting said data words into respective positions within said retrieved cache line.

8. A method according to claim 2, wherein each memory circuit comprises an additional cache way having an additional memory location, said additional cache way for storing a data word within said additional memory location, said data word derived other than from within said plurality if sequential data words.

9. A method according to claim 8, wherein said data word resides in other than the same cache line.

10. A method according to claim 8, wherein, said first memory location and said additional memory location share a same address within a memory circuit and form a same memory double word, wherein access to each memory location is provided by transferring either high bits or low bits of the same memory double word for retrieving of a data word.

11. A method according to claim 10, wherein the step of storing includes a step of storing within the same memory double word at a bit resolution of a size of a data word.

12. A method according to claim 8, wherein the first and second data words located at a same address within said first and second ways are other then from the same plurality of sequential data words.

13. A method according to claim 2, wherein the first memory circuit is dual ported.

14. A method according to claim 2, wherein the cache memory other than comprises a cache way prediction memory.

15. A method according to claim 2, wherein the first memory circuit and the second memory circuit are single ported memory circuits.

16. A cache data array, disposed within a cache memory, for storing a plurality of sequential data words, the data array comprising:
a first memory circuit having a first cache way therein for storing a first data word from the plurality of data words in a first memory location; and,
a second memory circuit having a second cache way therein for storing a second data word from the plurality of data words in a second memory location,
said first and second memory words stored in a same cache line and spanning said first and second cache ways, where adjacent data words are other than stored in a same memory circuit, with said first and second memory locations having an address within the cache way that is other than the same address.

17. A data array according to claim 16, wherein the cache memory other than comprises a cache way prediction memory for use in predicting a cache way within the data array.

18. A data array according to claim 16, comprising a data buffer, the data buffer for storing first and second sequential data words upon retrieval from the data array.

19. A data array according to claim 16 wherein the data array memory circuit is dual ported.

20. A data array according to claim 16, wherein for a system having N cache data array memories N data words are stored, one in each of the cache data array memories each stored such that the N data words are stored in sequential address locations within the N cache data array memories, one data word stored at each address location and one data word stored within each of the cache data array memories.

21. A data array according to claim 16, implemented within a single integrated circuit.

22. A storage medium having stored therein data for use in integrated circuit implementation including data representative of a cache data array, for being disposed within a cache memory and for storing a plurality of sequential data words, the data array comprising:
a first memory circuit having a first cache way therein for storing a first data word from the plurality of data words in a first memory location; and,
a second memory circuit having a second cache way therein for storing a second data word from the plurality of data words in a second memory location,
said first and second memory words stored in a same cache line and spanning said first and second cache ways, where adjacent data words are other than stored in a same memory circuit, with said first and second memory locations having an address within the cache way that is other than the same address.
